(19) United States
(12) Patent Application Publication
(10) Pub. No.: US 2026/0105809 A1
(43) Pub. Date: Apr. 16, 2026

(54) GENERATION OF IN-GAME CURRENCY BASED ON FITNESS DATA

(71) Applicant: Meric Odabas, Boca Raton, FL (US)

(72) Inventor: Meric Odabas, Boca Raton, FL (US)

(21) Appl. No.: 18/916,816

(22) Filed: Oct. 16, 2024

(51) Int. Cl. G07F 17/32; A63B 24/00

(52) U.S. Cl. CPC G07F 17/3255; A63B 24/0062; A63B 2024/0065

(57) ABSTRACT

A computer-implemented method includes hosting, by a game server, a gaming module and receiving, by the game server, fitness data from one or more devices of a user generated during gameplay. At least one device of the one or more devices includes one or more sensors configured for sensing the fitness data. The computer-implemented method further includes generating, by one or more processors, an in-game world and an in-game character movable therein, and generating, by the one or more processors, an in-game currency based on the fitness data.

### FIELD

The present disclosure relates to gaming, and more specifically, to a real and virtual world gaming system.

### BACKGROUND

The gaming industry includes location-based games. Such location-based games incorporate real world geography and the physical location of the player to enhance the player's overall gaming experience. Some location-based games key certain items and/or events in the virtual world to a particular location in the real world. Other location-based games, often referred to as parallel reality games, include a virtual world that parallels the real world. The virtual world can have virtual recreations of buildings, statues, objects, or other geographical elements which exist in the real world.

In the fitness industry, it is known to incorporate various types of technology to monitor and record the performer's vitals and fitness goals. For instance, various wearable electronic devices exist to record the performer's heart rate, blood pressure, or step count. After performance of a given activity, the performer may review and share their performance. Thereby, the performer may be further encouraged to maintain and achieve their fitness goals through the positive reinforcement of personal and peer review.

Some games, such as VR games, incorporate the use of fitness activity to help players have more fun as they do their exercises. Such games are of great benefit to the players as they typically incorporate physical and mental exercise, competition, and camaraderie amongst other players. Improvements are needed in the fitness gaming industry to further encourage a player to exercise whilst also having more fun in the game as an individual and collectively as one of many players.

### SUMMARY

In one embodiment, there is provided a computer-implemented method. The computer-implemented method includes hosting, by a game server, a gaming module and receiving, by the game server, fitness data from one or more devices of a user generated during gameplay. At least one device of the one or more devices comprises one or more sensors configured for sensing the fitness data. The method further includes generating, by one or more processors, an in-game world and an in-game character movable therein. The method further includes generating, by the one or more processors, an in-game currency based on the fitness data.

In one embodiment, the currency is usable to move the in-game character throughout the in-game world.

In one embodiment, the currency is usable to accomplish one or more in-game activities including: moving the in-game character in the in-game world, moving the in-game character at a set speed throughout the in-game world, collecting and storing one or more in-game virtual monsters in a battle queue, auto-catching, auto-queuing, or auto-battling one or more virtual monsters, scanning an area of the in-game world for in-game elements, including collectible items and/or virtual monsters, queueing one or more in-game tasks, and/or performing or speeding up the one or more tasks which decreases a preset completion time of the one or more tasks.

In one embodiment, in generating the currency, the fitness data is converted to the currency in real time, and player movement, when moving the in-game character in the in-game world as directed by the user, is contingent on the currency which is generated in real time.

In one embodiment, the method further includes generating, by the one or more processors, a predetermined pathway to facilitate player movement in the in-game world, and expending the currency to move the in-game character along the predetermined pathway in real time.

In one embodiment, the method further includes generating, by the one or more processors, a currency ledger wherein the currency is stored and subsequently usable by the user.

In one embodiment, the method further includes generating a currency overlay of the ledger that is displayed over the in-game world.

In one embodiment, the currency overlay is an interactive currency overlay, allowing the user to select one or more expenditure rates of the currency to speed up one or more in-game operations at a rate proportional to the one or more expenditure rates of the currency.

In one embodiment, each expenditure rate of the currency is based on the fitness data.

In one embodiment, the fitness data comprises heart rate data. The method further includes generating, by the one or more processors, a first expenditure rate based on a first heart rate range and a second expenditure rate based on a second heart rate range, and wherein the second expenditure rate is higher than the first expenditure rate and the second heart rate range is higher in heartbeats per minute than the first heart rate range.

In one embodiment, the fitness data comprises a distance traveled by the user in the real world, a number of steps by the user, a heart rate of the user, an optimal heart rate of the user, and/or an exercise time of the user.

In one embodiment, in generating the currency, the fitness data is converted to the currency via multiplying a total distance, a time, an average heart rate, or a number of steps of a fitness activity by a conversion factor.

In one embodiment, the fitness data comprises heart rate data, and in generating the currency, the heart rate data is converted into the currency via one or more predetermined functions.

In one embodiment, the method further includes generating, by the one or more processors, two or more zones including a first zone and a second zone. The first zone is a safe zone within which player movement does not expend currency. The second zone is an explorable zone within which player movement expends currency. The method further includes generating, by the one or more processors, one or more in-game virtual monsters, generating, by the one or more processors, a rarity factor of each virtual monster based in part upon a distance, within the in-game world, from the safe zone, and placing, by the one or more processors, the one or more virtual monsters on the in-game world in the explorable zone.

In one embodiment, the method further includes generating, by the one or more processors, one or more in-game items, including virtual monsters, and prompting the user to spend the generated in-game currency to: purchase the one or more in-game items, unlock playable zones of the in-game world, increase or add to in-game abilities of the in-game character, and/or increase or add to in-game abilities of the virtual monsters.

In one embodiment, there is provided a computer-based system for implementing a computer-implemented method of gaming. The system includes a game server comprising one or more computer-readable media, one or more processors, and a network interface, the game server configured for hosting a gaming module, receiving, by the network interface, fitness data from one or more devices of a user generated during gameplay, at least one device of the one or more devices comprising one or more sensors configured for sensing the fitness data, generating, by one or more processors, an in-game world and an in-game character movable therein, and generating, by the one or more processors, an in-game currency based on the fitness data. The currency is usable to move the in-game character throughout the in-game world. The game server is further configured for transmitting, by the network interface, the in-game world to the one or more user devices of the user.

In one embodiment, there is provided a computer-implemented method. The method includes hosting, by a game server, a gaming module and receiving, by the game server, fitness data from one or more devices of a user generated during gameplay. At least one device of the one or more devices includes one or more sensors configured for sensing the fitness data. The method further includes generating, by one or more processors, an in-game world and an in-game character, and moving the in-game character within the in-game world at a distance proportional to the fitness data.

In one embodiment, the method further includes generating, by the one or more processors, units of distance within the in-game world based on the fitness data, and generating, by the one or more processors, a conversion ratio for converting the fitness data to the units of distance such that player movement in the in-game world is proportional to the fitness data of the user.

In one embodiment, the method further includes generating, by the one or more processors, an expenditure ratio for depleting the units of distance, wherein the expenditure ratio is dependent upon a speed of player movement.

In one embodiment, player movement, in moving the in-game character through the in-game world, is tap based such that the in-game character is movable between a starting point and a selected destination point, wherein a pathway between the starting point and the selected destination point is determined by the one or more processors and costs a corresponding amount of the units of distance, freeform such that the in-game character is freely movable, by the user, in any direction throughout the in-game world such that each increment of movement costs a preset amount of units of distance, or preset directional such that the in-game character is movable in a preselected direction, which is selectable by the user, and player movement is contingent on the fitness data.

### BRIEF DESCRIPTION OF THE DRAWINGS

The embodiments illustrated herein are not limited to the precise arrangements, sequential steps, and dimensions shown. Like numerals indicate like elements throughout the drawings. In the drawings:

FIG. 1 depicts a computer-based system for implementing a fitness-based game according to an exemplary embodiment of the present disclosure;

FIG. 2 depicts a game server of the computer-based system FIG. 1;

FIG. 3 depicts a graphical representation of a game world, wherein player movement is achieved through a tap based movement modality where a user can tap or select a destination and one or more predetermined pathways are generated to allow the player to move to the selected destination;

FIG. 4 depicts a graphical representation of a freeform based movement modality within the game world, wherein a user can freely move without moving along predetermined pathways;

FIG. 5 depicts a graphical representation of a direction based movement modality within the game world, wherein a user can select a direction of travel and thereafter the in-game character will move in the selected direction, contingent upon the fitness data;

FIG. 6 depicts a graphical representation of a game world, illustrating a first city zone, a second city zone, and an explorable zone thereof with findable virtual monsters which have differing rarities based at least in part upon their distances from the first and second city zones;

FIG. 7 depicts another graphical representation of an exemplary game world with multiple option overlays, including a rate of travel overlay, a currency ledger overlay, and a battle queue overlay;

FIG. 8 depicts another graphical representation of an exemplary game world, illustrating independent users and grouped users within the game world;

FIGS. 9A and 9B depict graphical representations of a base view for viewing an explorable zone of the game world and an expanded view which has an augmented viewable window in comparison to the base view, respectively;

FIG. 10 depicts a graphical representation of an explorable zone wherein a user can drop a pin to view various in-game elements within a scanned or revealed viewable window or proximity zone corresponding the dropped pin;

FIG. 11 illustrates a flowchart of a computer-implemented method for generating in-game currency based on sensed fitness data;

FIG. 12 illustrates a flowchart of a computer-implemented method for tethering real word fitness data to in-game player movement throughout the game world in real time;

FIG. 13 illustrates a flowchart of a computer-implemented method for generating and storing in-game currency in a currency ledger, allowing the user to store and subsequently use the currency on in-game activities; and

FIG. 14 illustrates a flowchart of a computer-implemented method for generating virtual elements in a game world with multiple zones and subsequently allowing the user to search for the generated virtual elements via one or more viewing windows.

### DETAILED DESCRIPTION

As used herein, the term “game world” can refer to a computer generated, playable area or areas. The game world can comprise a 2D and/or 3D graphical illustration. The game world can be generated in any desired manner and may thus be finite, which may be the same for all players, continuous, or procedural with pseudo random generation, which may be individualized for each player. In one embodiment, the game world can be pre-generated by the gaming module, the devices of the users can display the game world, freely and continuously move therein, and the game server will generate, transmit, and dynamically update the devices with player locations, in-game item locations, new or altered regions or zones, and story events. The game server may not generate the game world in real time but may dynamically alter game data and update the user devices to provide a collectively homogenous and/or individualized experience for the player(s) in real time based on real world events (e.g., sensed data including player location, fitness data, etc.). The term “map” may refer to a graphical illustration or representation of the game world, including a map of all or some of playable areas, which can be a separate graphical illustration and/or a map overlay displaying a mini map directly over the display of the game world. The term “continuous map” may refer to a map that has an open world component wherein one or more portions or zones of the map are freely explorable by the player (as opposed to fixed, unexplorable points on a fixed-destination map). Hence the game world and map thereof can be freely explorable by the player(s), moving in any desired direction throughout the playable area(s).

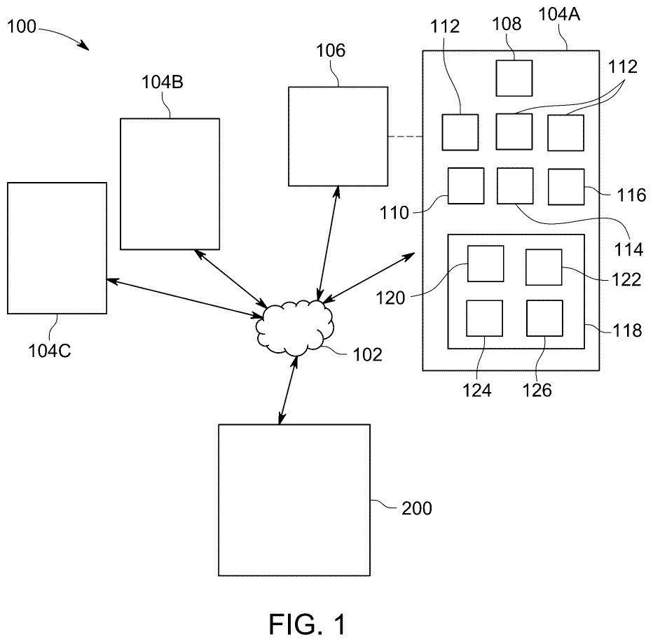

FIG. 1 illustrates an exemplary computer-based system 100 for implementing a fitness-based game. The system 100 may include a network 102, devices 104A, 104B, 104C, 106 of the players, i.e., users of the fitness-based game, and a game server 200 connected to the devices 104A-C, 106 via the network 102. The system 100 may comprise a fitness gaming application with an integrated video game which is downloadable onto one or more devices 104A-C, 106. The system 100 may encourage exercise by integrating a video game into the entire fitness process. It is conceivable that in other embodiments, the system 100 may include different or additional elements from what is illustrated in FIG. 1.

The system 100 relates exercise to various in-game elements when playing the video game. In one embodiment, the system 100 awards fitness activities of the users by providing an in-game currency based on the fitness activity. As used herein, the term “currency” may refer to an in-game value system wherein real world fitness activity is transmuted into an in-game value system, which can be measured or awarded in units of points (akin to a bank note), a distance increment, a speed of travel (i.e., the time it takes to travel throughout the game world), and/or a time of travel (i.e., the amount of time a user may move throughout or explore portions of the game world). As discussed further herein, the system 100 can generate the in-game currency based on fitness activity, including a distance traveled in the real world, steps, heart rate data (elevated or optimal), the type of fitness activity, the location of the user when performing the fitness activity, goals achieved by the player, and/or other fitness metrics.

In one embodiment, the system 100 allows the in-game character of the playable character to move around an in-game world at a distance proportional to their fitness (which is independent of the player's real world location and present direction or heading). As discussed in more detail below, the fitness data of the player can be converted to an in-game distance (or unit of distance) in real time or can be stored as an in-game currency in a currency ledger for later use in the game. As the player selects to perform various in-game activities, such as moving throughout the in-game world, the in-game currency will become depleted and thus require the player to perform additional fitness activities in the real world.

In one embodiment, the system 100 may make movement in the game world completely contingent upon movement in the real world, wherein the player must perform a fitness activity in order to receive a corresponding allotment of distance currency, which can be used to move the in-game character of the player's character throughout a particular zone or zones of the map of the game world. The system 100 may further allow the in-game currency to provide additional perks beyond in-game movement, as discussed further herein. As used herein, a “battle option” can refer to an option to battle, i.e., virtually fight, one or more in-game characters, such as monsters for the purpose of capturing and collecting the monsters. As used herein, a “monster” can refer to any in-game character. As used herein, the term “battle queue” generally refers to a listing of options to battle collected monsters. As used herein, the term “currency queue” or “currency ledger” can refer to a listing of a total summary of the generated in-game currency, which can be provided to the player in real time.

In some embodiments, the monsters hidden throughout the in-game world can be found by the players and thereafter can be battled to capture other monsters, while the user is not presently exercising and thus generating fitness data. In this way, a fitness activity or fitness session is not interrupted as a video game playing session occurs at a separate time from the fitness activity. Since the video game fitness system 100 is not location-based, but is fitness-based instead, there will not be a reason to be in the same physical and/or virtual location related to any other player, monster, or other in-game element. Thereby, in some embodiments, the players may not be advantaged or disadvantaged by residing in any particular location and/or traveling to any particular location.

The network 102 can be any type of communications network, such as a local area network (LAN), wide area network (WAN), a public network, and/or some combination thereof. In general, communication between the game server 200 and the various devices 104A-C, 106 may occur via any desired network interface using any type of wireless connection, using a variety of communication protocols (for example UDP, TCP/IP, HTTP, S1v1TP, FTP), encodings or formats (for example HTML, JSON, XML), or protection schemes (for example VPN, secure HTTP, SSL).

The devices 104A-C and/or device 106 can be connected to the network 102. The devices 104A-C, 106 can be associated with one or more players and/or with one another. A single user may have two or more devices 104A, 106, which can be associated with one another, as denoted in phantom in FIG. 1. Each device 104A, 106 may communicate with the game server 200 individually via the network 102. Additionally or alternatively, one device 104A may communicate with the network 102, whereas the other additional device 106 may communicate with the device 104A instead of directly with the network 102. Hence, at least one of the devices 104A, 106, or both, may communicate with the game server 200, e.g., one or more components thereof, via the network 102.

The various client devices 104A-C, 106 may or may not be identical to one another. By way of example only, one player may have a smartphone 104A and a wearable or haptic device 106, such as a smartwatch, that is connected to the smartphone 104A and/or the network 102. It should be appreciated that the player may only have a smartphone 104A-C, have both smartphone 104A-C and wearable device(s) 106, or just a wearable device 106.

As illustrated with respect to the device 104A in FIG. 1, each device 104A-C may include input/output devices 108, e.g., a display screen, speakers, a local data storage 110, one or more sensors 112, one or more fitness applications 114, a notification module 116, and a fitness gaming application 118.

The one or more devices 106 associated with the user, in addition to or separate from the device 104A-C, may include input/output devices, e.g., a display screen, lights, speakers, etc., a local data storage, one or more sensors, a fitness application, which may or may not include a fitness data collection module, a notification module, and/or a fitness gaming application. The various components of the device 106 may be in the form of, or function similarly to, the various components of devices 104A-C, as described herein. The additional device 106 may or may not include the fitness gaming application 118. For instance, in the case where the device 104A is in the form of a smartphone 104A and the device 106 is in the form of a wearable device 106, the wearable device 106 may not include the fitness gaming application 118 in addition to the smartphone 104A. The devices 104A-C, 106 may also include other components known to those skilled in the art. Therein, the devices 104A-C, 106 may include any desired hardware and/or software for generating fitness data.

It should be appreciated that each user may have one or more devices 104A-C, 106 that may be stationary, portable, and/or wearable. As discussed above, the devices 104A-C may be in the form of smartphones and the device 106 may be in the form of a wearable device, such as a smartwatch or smart shoes. However, the devices 104A-C, 106 may also be in the form of a computer, a tablet, a navigation system, a handheld GPS system, user equipment (UE), a portable gaming device, a digital music player, a media player head-mounted display (HMD), a virtual and/or augmented reality headset, smart glasses, smart clothes, smart shoes, data gathering implants, and/or or other suitable data gathering electronic devices. It is conceivable that a device 104A-C may not include sensors 112 for sensing fitness data. Accordingly, such a device may still include the fitness gaming application 118 even though the device does not include the sensors 112. For instance, one device, such as a smartphone, computer, or gaming console, may be used to play the fitness-based game and one or more other devices, such as a wearable device, may include the sensors 112 for sensing the fitness data.

The local data storage 110 can be one or more computer-readable media configured to store data. For example, the local data storage 110 may store the fitness data generated by any desired fitness application and/or fitness collection module. The local data storage 110 may also store any other appropriate data. Furthermore, data may be stored elsewhere (for example, in a distributed database) and accessed remotely via the network 102.

The one or more sensors 112, integrated within the device 104A-C and/or device 106, may include a location sensor, in the form of a positioning device, a timer, a speed sensor, an accelerometer, a gyroscope, an altimeter, a pedometer, and/or a heart rate sensor. For instance, the positioning device may monitor the position of the smartphone and/or wearable device 104A-C, 106. In the present embodiment, the one or more sensors 112 include a positioning device, a pedometer, and a heart rate monitor. However, the one or more sensors 112 may include other and/or additional sensors as appreciated by the skilled artisan.

The positioning device can be any device or circuitry; for example, the positioning device may comprise a GPS system, a Galileo positioning system, a Global Navigation satellite system (GLONASS), a BeiDou Satellite Navigation, or a Positioning system. As the player moves around with the device 104A-C, 106 in the physical world, the positioning device can track the position of the player and provide player location data to the fitness gaming application 118.

The fitness application 114 monitors and collects fitness data associated with one or more fitness activities of a player. The fitness application 114 may be part of the device's 104A-C, 106 operating system or additional software installed by the player (e.g., an application installed for use with a wearable device such as a smartwatch or fitness tracker). The fitness application 114 may or may not include a fitness data collection module.

The fitness data may be collected by any appropriate fitness application(s). The fitness data may include activity time, i.e., the time at which a fitness activity starts and finishes, a location of the user, steps, a distance traveled, a heart rate of the player, and/or an amount of time spent exercising which is based upon an elevated heart rate level, both low intensity and high intensity when compared to the player's resting heart rate and/or optimal heart rate. The fitness data may also include values of variables over time, such as periodic (for example, every few seconds or per minute) measures of heart rate or time spent performing a specified exercise continuously. The fitness data may include any data associated with a fitness activity. As used herein, “fitness activity” can refer to any user activity in the real world. Additionally, the fitness data may include any data associated with the physical health of the player, whether the data is associated with a fitness activity or a non-fitness activity, such as sleep patterns or a normal resting state of the player. The fitness data can be raw data and/or preprocessed data from one or more fitness applications 114.

The notification module 116 notifies, or otherwise presents information to the player, via various visual and/or auditory signals which are known to the skilled artisan. The notification module 116 may comprise any desired software and/or hardware.

The fitness gaming application 118, executed by the device(s) 104A-C, 106, provides an interface between the player and the video game server 200. The fitness gaming application 118 can include a fitness collection module 120, a fitness data extraction module 122, a notification module 124, and/or native plugins 126. In some embodiments, the fitness gaming application 118 may not include native plugins 126; and therein, the fitness gaming application 118 may receive fitness data directly from fitness application(s) 114 of the device 104A-C and/or device 106.

The fitness collection module 120 collects the fitness data. The fitness collection module 120 may be part of the fitness gaming application 118. The fitness collection module 120 may be separate from and/or at least partially incorporated with other fitness collection modules of the device(s) 104A-C, 106. Therein, the fitness collection module 120 can be a part of the fitness gaming application 118 or both of the fitness application 114 and fitness gaming application 118. It is noted that the fitness data may be collected by any appropriate fitness monitoring application in communication with the one or more sensor(s) 112 of the device(s) 104A-C, 106.

The fitness data extraction module 122 extracts fitness data generated by the fitness collection module 120 and sends it to the local data storage 110 and/or the game server 200. The fitness data extraction module 122 may be part of the fitness gaming application 118. In some embodiments, the fitness data extraction module 122 executes a process that periodically checks for updated fitness data. The fitness data extraction module 122 may filter the fitness data based on the source of the fitness data. The fitness data extraction module 122 sends the fitness data, subject to any filtering applied, to the game server 200 in conjunction with an identifier of the corresponding player.

In some embodiments, the fitness data extraction module 122 can extract the fitness data depending on one or more parameters. For instance, the fitness data extraction module 122 may continually extract fitness data at predetermined intervals so that the game server 200 may generate in-game elements in real time. Additionally, for instance, the fitness data extraction module 122 may extract fitness data only after the sensor(s) 112 of the device(s) 104A-C, 106 register a certain heart rate of the player, such as a resting heart rate of the player. The fitness data extraction module 122 may also extract fitness data upon or shortly after downloading the fitness gaming application 118. The game server 200 may determine the player's resting heart rate, e.g., 50-80 bpm, via the fitness collection and extraction modules 120, 122. Alternatively, the game server 200 may store an average heart rate instead of a specific resting heart rate of the player. Thereby, the fitness gaming application 118 and/or the game server 200 may not extract fitness data and/or generate in-game content based on the fitness data without first ensuring the player is finished exercising. Hence, the mental health and/or the safety of the players may be augmented by eliminating various distractions during their fitness activities.

The notification module 124 of the fitness gaming application 118 can be separate from the notification module 116 of the device(s) 104A-C, 106. Alternatively, the notification module 124 of the fitness gaming application 118 may be in the form of, or at least partially incorporated into, the notification module 116 of the device(s) 104A-C, 106. As shown, the fitness gaming application 118 includes a notification module 124 which communicates to the notification module 116 of the device(s) 104A-C, 106. The notification module 124 may receive communication from the game server 200. For instance, the game server 200 may communicate with the notification module 124 when the fitness data, provided by the fitness data extraction module 122, reaches a predetermined level. The notification module 124 may communicate various messages in a variety of manners known to the skilled artisan.

The fitness gaming application 118 also presents a player interface of the game on the display screen(s) of the device(s) 104A-C, 106. Thereby, the fitness gaming application 118 allows the player to interact with the game to perform various game activities. The fitness gaming application 118 also controls various other outputs to allow a player to interact with the video game server 200 without requiring the player to view a display screen. For example, the fitness gaming application 118 may control various audio, vibratory, visual, or other notifications. The fitness gaming application 118 accesses game data to provide an accurate representation of the current state of the game to the player. The fitness gaming application 118 receives and processes player input and provides updates to the game server 200 over the network 102.

In some embodiments, the player must download the fitness gaming application 118 onto their device 104A-C and/or 106. As a result, the device(s) 104A-C, 106 can execute software to allow the player to be monitored and fitness data collected. The player can play the game after monsters and/or battle options have been generated in accordance with the video game fitness system 100.

The device 104A-C and/or device 106, for example the fitness data extraction module 122 thereof, can retrieve fitness data in a foreground and/or background process. Continually therewith, in real time, and/or thereafter, in a bulk communication after a preset condition, the fitness data extraction module 122 may send the fitness data to the game server 200. A foreground process is one that the player is actively aware of while using the fitness gaming application 118, whereas a background process performs an operation that is not directly noticed by the player. In a foreground process, the player can have the fitness gaming application 118 open on their device 104A-C, 106 to visually see updates related to their activity.

In a background process, the player can lock their display screen, with the fitness gaming application 118 still open, and/or close the fitness gaming application 118. The background process will continue collecting fitness data. For instance, one or more fitness applications 114 may continue to collect fitness data, and the fitness data extraction module 122 may accordingly receive the fitness data.

By way of example, the fitness gaming application 118 may employ the native plugins 126 to handle the fitness data collection. This way, the native plugins 126 can continue to run in the background to collect the needed fitness data. The native plugins 126 may communicate with the game server 200 when the fitness gaming application 118 is open. When the device 104A-C, 106 and the fitness gaming application 118 are open, the fitness gaming application 118 can be considered to be operating in the foreground mode.

For instance, when the player walks around with the fitness gaming application 118 open, the fitness gaming application 118 itself can collect the fitness data. However, the native plugins 126 can be used to collect the fitness data in the foreground as well as background, and then subsequently send the fitness data to the game server 200 for processing.

In some embodiments, the native plugins 126 accumulate data in the background and send the data to the game server 200 for processing in the background. The player would simply see the updated information when they opened the fitness gaming application 118 again. In accordance with other embodiments, the native plugins 126 accumulate data in the background, then when the fitness gaming application 118 is opened, the native plugins 126 provide the data to the fitness gaming application 118, and the fitness gaming application 118 itself, in the foreground, sends the data to the game server 200 to be processed.

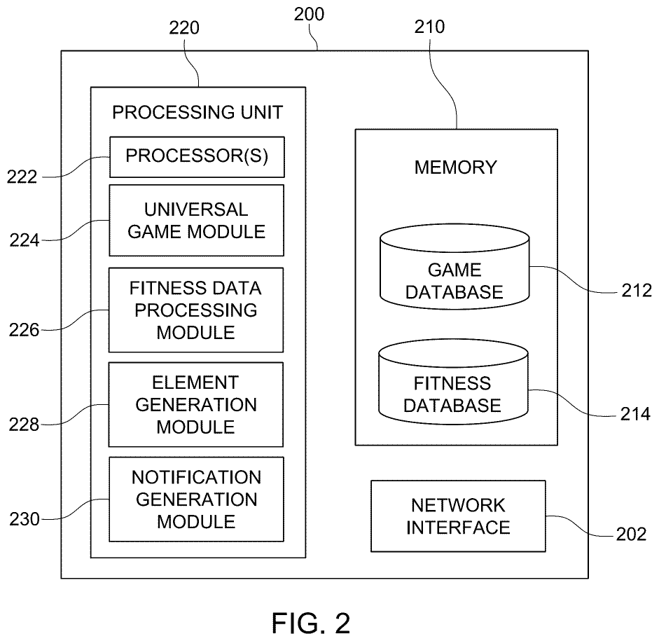

Referring now to FIG. 2, the game server 200 includes a network interface 202, a computer-readable storage media 210, such as a memory, and a processing unit 220. The game server 200 hosts the fitness-based game, receives and analyzes inputs, e.g., the fitness data, and provides various game status updates to at least one of the devices 104A-C, 106 of the players. In some embodiments, the game server 200 may contain different or additional elements, and the various functions thereof may be distributed among its various elements in a different manner than described herein.

The network interface 202 establishes communication between the game server 200 and the network 102. The network interface 202 can include any suitable components for interfacing with one or more networks, including, for example, transmitters, receivers, ports, controllers, antennas, or other suitable components.

The memory 210 stores game data and the collected fitness data from the players. The memory 210 may generally include any suitable computer readable media, transitory or non-transitory, for storing instructions. The memory 210 includes a game database 212 and a fitness database 214. The game database 212 and/or the fitness database 214 may be part of the game server 200 or separate from the game server 200 and accordingly be remotely accessed through the network 102. The game database 212 may store information associated with the fitness-based game. The fitness database 214 may store information associated with the fitness and non-fitness activities of the players. In some embodiments, the memory 210 may include a single database, such as a game and fitness database, which stores both fitness and game data.

The processing unit 220 generally includes one or more processors 222 for executing computer-readable instructions. The processing unit 220 may further include a universal game module 224, a fitness data processing module 226, an element generation module 228, and a notification generation module 230.

The one or more processors 222 may comprise any desired software and hardware. The one or more processors 222 may perform the various functions of the processing unit 220 described herein.

The universal game module 224 hosts and generates game content for the players. The universal game module 224 can be referred to as a fitness-based gaming module, wherein the generated virtual content, which impacts the game, is generated at least in part upon the fitness activity of the players in the real world. For instance, the universal game module 224 may generate a game world, a map or mini map of the game world, an overlay of the generated map onto the game world, generate one or more virtual elements, such as monsters, items, bonusses, option overlays to select and/or accomplish various in-game tasks, and populate the game world and/or map with in-game character(s), monsters, items, story events, etc. The universal game module 224 may access and store data in the game database 212 and the fitness database 214. The universal game module 224 can further govern device connectivity and the security thereof. It is noted that the fitness data processing module 226, the element generation module 228, and/or the notification generation module 230 can be a part of or separate from the universal game module 224.

The fitness data processing module 226 may receive fitness data associated with the fitness activity of the players, by way of the various sensors 112 of the devices 104A-C, 106 of the players. For instance, the fitness data processing module 226 may retrieve fitness data by a background process of the one or more devices 104A-C, 106 of the player. The fitness data processing module 226 may also process the fitness data. Therein, the fitness data processing module 226 may determine a type of fitness activity, a duration of a fitness activity, a resting heart rate of a player, a resting heart rate range of a player, an average heart rate, an optimal heart rate or optimal heart rate range of one or more players, the number of steps of the player in a fitness activity, an average number of steps of the player within a certain time period, a distance traveled of the player based on pedometer data and/or location data, and/or any other desired fitness metric associated with the fitness activity of the players.

For example, considering the heart rate of the player, the fitness data processing module 226 may determine one or more parameters related to a duration of elevated heart rate, a heart rate intensity, and/or an optimal heart rate for subsequently generating in-game elements. The optimal heart rate may be a precalculated parameter or may be individually calculated for each player by evaluating the player's resting and active heart rates. The fitness data processing module 226 may determine a primary parameter, such as whether the heart rate of the player is active, e.g., 80-220 bpm, and a secondary parameter, such as the particular heart rate of the player at a given time within the fitness activity, which together may be used to generate in-game elements, e.g., currency. The secondary parameter can be keyed to a multiplication factor which in turn increases the battle option generation rate. The fitness data processing module 226 may also determine a first factor based on the heart rate of the user and a second factor based on an optimal heart rate. The optimal heart rate factor can be greater than the actual heart rate factor. Hence, the amount of currency, e.g., units of traversable distance, may taper off asymptotically, akin to a normal distribution, at very low and high heart rates. The fitness data processing module 226 may generate a first multiplication factor, e.g., 1.2×, based on the heart rate of the user and a second multiplication factor, e.g., 4×, based on an optimal heart rate, or range thereof, of the user. For example, a heart rate at 120 beats per minute (or range thereof, plus or minus 10 beats per minute) for a given time period may yield a greater amount of currency than a heart rate of 100 beats per minute (or lower) and also 160 beats per minute (or greater). In other words, high heart rates, e.g., 160-180 beats per minute, may yield less currency than optimal heart rates, e.g. 110-130 beats per minute. Thereby, exercises with an extreme intensity are not significantly rewarded, which encourages players to be cognizant of their limits to help reduce risk of injury, e.g., pulling or straining a muscle. Also, those players who may be less physically fit may be awarded a comparable amount to or more battle options than those who are more physically fit.

In one embodiment, the fitness data processing module 226 may also generate a limit factor based on the fitness data, which can be subsequently used by the element generation module 228 to reduce an amount of generated in-game elements, e.g., currency. For example, the fitness data processing module 226 may process the fitness data and determine that the player has excessively exercised within a given time period as judged by historical player fitness data, e.g., identifying that a player has ran 100 miles in two days and has never before reported fitness data akin to an ultra-marathoner. If so, the limit factor, e.g., 0.3×, may be generated and used to reduce the amount of generated in-game elements in order to discourage excessive exercise, which may lead to injury to the player.

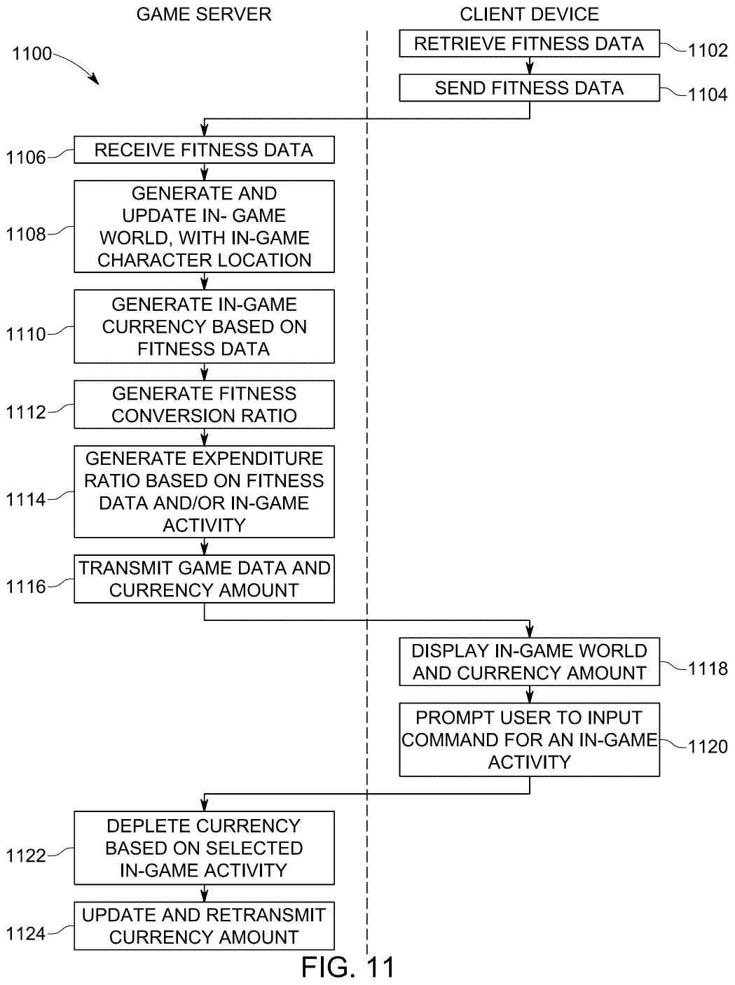

The element generation module 228 can receive the fitness data from the fitness data processing module 226. The element generation module 228 can generate in-game content, including a variety of in-game elements and features. More specifically, the element generation module 228 may generate in-game currency based on the fitness activity and any factors generated by the data processing module 226. As discussed below with respect to FIG. 11, the element generation module 228 may generate currency and various options to use the currency based on various types of fitness data, whether received and generated in real time or not.

The notification generation module 230 may notify the players about the various in-game content which was generated as a result of their fitness activity. The notification generation module 230 may comprise any desired hardware and software. The notification module 230 may communicate various messages in a variety of manners known to the skilled artisan. In some embodiments, the notification generation module 230 may prevent the notification of the generated in-game content from the game server 200 depending on one or more parameters. For instance, the notification generation module 230 may only notify the player after the sensor(s) 112 of the device(s) 104A-C, 106 register a certain heart rate of the player, such as a resting heart rate of the player. Hence, the notification generation module 230 may assure that the player is not distracted during their fitness activity.

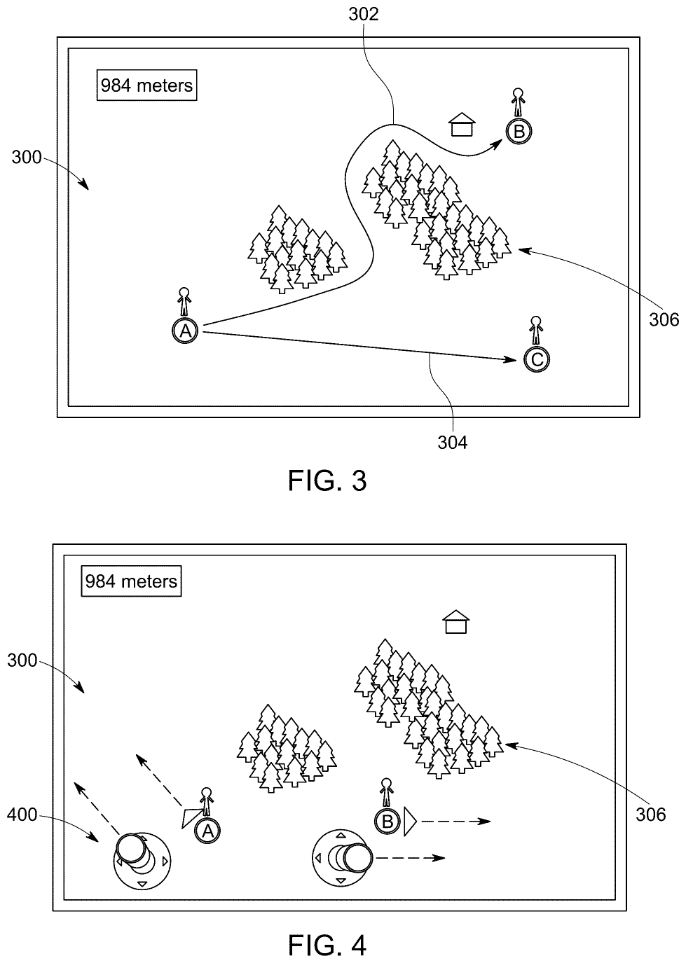

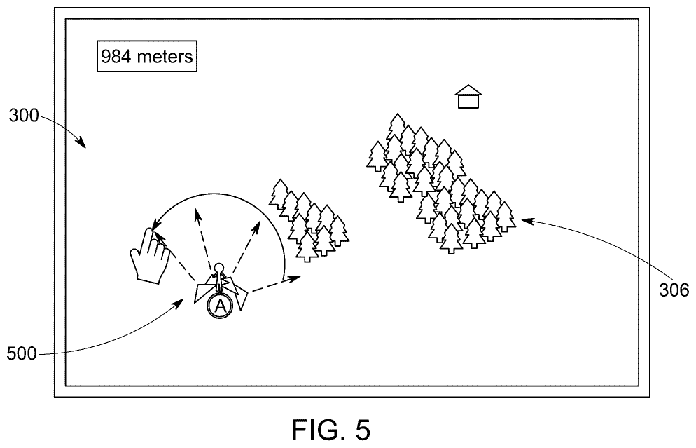

Referring now to FIGS. 3-5, there are shown examples of graphical user interfaces of in-game worlds 300 and corresponding player movement modalities thereof. The illustrated graphical user interfaces may be representations of the game world or a map or mini map thereof. FIG. 3 illustrates tap based player movement. FIG. 4 illustrates freeform or joystick based movement. FIG. 5 illustrates preset directional based movement.

In the exemplary in-game world 300 as shown in FIG. 3, player movement is accomplished by tapping on or otherwise selecting a location (such as a point of interest or an arbitrary point on the in-game world 300), generating by the element generation module 228 one or more travel pathways 302, 304, selecting a desired pathway, and thereafter traveling to the selected location.

In one embodiment, the element generation module 228 may generate multiple pathways that are optimized according to various criteria. For instance, the element generation module 228 may generate a direct pathway that uses the least amount of currency in order to travel from point to point. This direct pathway may or may not be a straight line, as there may exist obstacles in between the player's location and the desired destination which may require the element generation module 228 to generate a curved or multi-directional pathway(s) to create the quickest route (which uses the least amount of currency). For example, as shown in FIG. 3, a straight path to the house at location B is not possible as two obstacles, e.g., forests 306, exist in between the in-game character, at location A, and the house at destination B. Thereby, the element generation module 228 cannot provide a straight line between the two locations, and thus generates a multi-curved pathway around each forest 306.

Additionally, the element generation module 228 may generate one or more item-optimized pathways that are optimized for playable content, wherein the pathway is optimized so that the player encounters multiple in-game items, such as monsters or other collectibles, in between the player's location and the desired destination. The item-optimized pathway will typically cost more currency than a direct pathway, however the player will encounter more items. The element generation module 228 may also generate travel pathways based on optimizing encounters with particular items, in-game events, other players, etc. For instance, the element generation module 228 may generate a monster optimized pathway wherein the player encounters a greater number of monsters between two points in the game world, or map thereof, in comparison to another differing pathway.

To help the player decide which travel pathway to choose, the element generation module 228 may also generate an optimization overlay displayed over or next to a possible travel pathway, wherein the optimization overlay displays additional information, including the cost of the pathway, the feature or item of optimization, an event optimization, a clan or other player optimization, the number of items (e.g., monsters) which will be encountered along the pathway, a travel time, and/or any other desired information.

In one embodiment, the element generation module 228 may automatically select one or more generated travel pathways. In one embodiment, the element generation module 228 may only generate one travel pathway. In such embodiments, the element generation module 228 may automatically select the pathway and move the player there along, without further player input after the player selects a particular location. The element generation module 228 may automatically calculate the single pathway to the destination point based on a predetermined optimization feature, such as the fastest pathway, most items encountered, most points of interest, temporary or storyline events, etc. Therein, the user may initially select an optimization feature and thereafter the element generation module 228 will optimize for this selected feature unless and until the player selects a differing optimization feature.

In one embodiment, the currency is stored and depleted as the in-game character travels along the selected path. In another embodiment, the currency is not stored, wherein movement in the game world is accomplished in real time as the player walks in the real world (or performs another fitness activity). If the player stops the fitness activity, the in-game character will accordingly cease moving in the in-game world, but the pathway will remain in existence so that the in-game character can subsequently move there along when the user desires to restart or start a new fitness activity.

In one embodiment, the currency may be stored and/or spent in real time as the player moves in the real world. For example, the game server 200 may generate and spend the currency in real time as the player does a fitness activity, and in addition thereto, the game server 200 may store any excess currency that was generated from this particular fitness activity.

In the exemplary in-game world 300 as shown in FIG. 4, player movement is accomplished by freeform movement. In one embodiment, the element generation module 228 generates a movement overlay 400, e.g., a joystick and/or one or more buttons overlayed onto the in-game world 300 which allow the player to orient and move the in-game character in any desired location throughout the in-game world 300. Thereby, the player may use the joystick and move in any desired direction whilst the element generation module 228 depletes the currency as the in-game character moves about the in-game world 300. As shown in FIG. 4, the in-game character A is presently traveling toward the left to move around a nearby forest 306, and the in-game character B is presently traveling toward the right to move around both forests 306 in order to reach the house. In one embodiment, the currency can be depleted in real time as the player manipulates the movement overlay 400. In one embodiment, the currency can be stored so that the player may move the in-game character in any desired direction and time.

In the exemplary in-game world as shown in FIG. 5, player movement is accomplished by a preset directional based movement modality. In other words, the user may select a particular direction via a movement overlay 500 and the element generation module 228 will automatically move the in-game character through the in-game world at a set distance or variable distance.

In one embodiment, player movement may be accomplished in real time. For instance, the distance traveled along a particular direction can be tethered to a real world distance traversed by the player in real time (or multiple thereof calculated by the element generation module 228). In one example, the player may play the game in the foreground, wherein the player may set a particular direction of travel, and thereafter begin walking (or performing another fitness activity) while have the game open in the foreground so that the in-game character will correspondingly move through the in-game world 300. Thereby, the player can watch the in-game character move throughout the in-game world 300 in real time as the player walks (or performs another fitness activity). In one embodiment, the currency can be stored and used as desired, in which case the element generation module 228 may move the in-game character in the preselected direction at a predetermined amount, until an item is encountered, and/or until the stored currency is depleted.

The player may select a particular direction via using the movement overlay 500, which is generated by the element generation module 228. For example, the movement overlay 500 may comprise an arc, one or more arrows, and/or one or more buttons that allow the player to swipe along the arced pathway or select, e.g., tap, on one of multiple possible directional arrows in order to choose a given direction. For instance, the player may initially tap and hold on the arc, which then reveals multiple different arrows, and once a desired direction is swiped to, the player may release their finger, and the in-game character will begin moving in the selected direction. Haptic feedback may be provided to the player to ensure that the player knows when a directional arrow has been selected. The arc may allow the user to swipe 360 degrees around the in-game character. The movement overlay 500 can be displayed above, below, on top of, or at a set distance away from the in-game character. After selecting a particular direction, the player may subsequently choose a new direction at will. In another example, the player may play the game in the background and the in-game character will move throughout the in-game world 300 in a background process as the player moves or accomplishes certain fitness activities in the real world.

In any of the player movement modalities, the element generation module 228 may generate the currency in real time or not. If generated in real time, the currency may be depleted in real time. In another embodiment, the currency can be stored in a currency ledger in the memory 210 and used later by the player (whether or not the player is presently performing a fitness activity). Thereby, the currency can be generated and stored, in a time-independent manner, and also the currency may be generated and spent in real time, in a time-dependent manner. In some embodiments, the stored currency may expire or diminish in value (or the amount thereof) over a predetermined amount of time, thus motivating the player to use the currency within the threshold time period and begin exercising anew.

In any of the player movement modalities, the element generation module 228 may generate multiple preset speeds or allow for a real time variable speed. For example, the element generation module 228 may provide preset speeds, such as a walking speed, a very slow “no energy” speed when the currency is depleted, a faster jogging or running speed that may deplete a greater amount of currency, and/or a hyper fast sprinting speed that is faster than the running speed.

The element generation module 228 may also deplete (or not deplete) currency in relation to the movement speed of the in-game character throughout the in-game world 300. For example, in some embodiments, the walking speed may not deplete any currency. Therein, the player may move about the in-game world 300 at a walking speed without depleting any currency. In some embodiments, the walking speed may deplete a preset amount of currency per in-game step (or measure of distance) or for a duration of time. In some embodiments, the running speed may deplete more currency than the walking speed. For instance, a walking speed may deplete the currency at a 1-1 ratio, where one step of in-game player movement depletes one unit of the currency, e.g., an incremental distance unit. A running speed (faster movement than the walking speed) may deplete the currency at a 2-1 or 3-1 ratio (or more), where one running step depletes two or more units of the currency. A fast-travel option may allow the player to instantaneously travel to a location within the game world at a certain cost.

Additionally, for example, the element generation module 228 may sense the fitness data in real time and accordingly generate a speed of movement in proportion to the sensed fitness data. Therein, if a player is walking or running in the real world (or performing an activity with a low heart rate or high heart rate), the in-game character in the game may travel at a corresponding and proportional speed through the in-game world 300. With real time variable speed, the element generation module 228 will move the in-game character along a pathway or in a particular direction at a speed that is related to the real world speed (or heart rate) of the player. For instance, as the real time fitness data is received and processed, which may be in the form of user steps, heart rate intensity, GPS location data, actual or estimated distance traveled, etc., the player movement speed of the in-game character will be in proportion to the intensity of the fitness activity in the real world, in real time, such that the in-game character may move at numerous different speeds in a particular travel pathway or direction (or for a particular amount of time).

In some embodiments, the element generation module 228 may directly tether in-game player movement to real world fitness activity of the player (or a grouping of players in a particular clan or group). In some embodiments, the element generation module 228 may adjust the speed of the in-game character in real time and may also store currency for subsequent usage. For example, if the in-game character completes a given travel path in the in-game world 300 (or completes a predetermined number of steps or time duration), and if the player keeps exercising in the real world, the element generation module 228 may keep sensing and processing the fitness activity to store any additional currency in the currency ledger for subsequent usage. As can be appreciated, the notification module 230 may notify the player at any time throughout movement of the in-game character, for example notifying the player that the speed of the in-game character has changed or that a movement procedure for a given pathway has been completed.

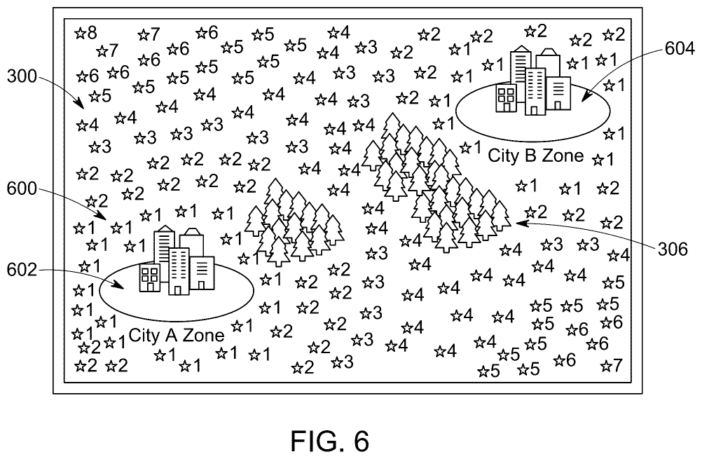

Referring now to FIG. 6, there is shown an example of a graphical user interface of an in-game world 300 of the game world, which is generated at least in part upon the fitness data. The in-game world 300 can be an approximation of, or correlated to, the real world, or an arbitrary (i.e., fake) fantasy world that is independent of the real world. As shown in FIG. 6, the stars represent locations of monsters and the numbers positioned adjacent thereto indicate the rarity of the monsters, wherein a higher number indicates a more rare or unique and typically stronger monster. As used herein, the rarity and/or commonality associated with a monster can refer to a numerical value of the monster and/or the various characteristics of the monster. For instance, the rarity of a monster may refer to the unique characteristics, e.g., the strength, health, design, etc., of a particular category of monsters. Additionally, the element generation module 228 can generate both rare and common virtual monsters using a rarity factor and/or a commonality factor, which was generated by the fitness data processing module 226.

The in-game world 300 may include one or more zones or regions, which may differ from one another. For example, the in-game world 300 may include one or more unsafe (e.g., explorable) zones 600 and/or safe (e.g., city, village, clubhouse, house, regional, etc.) zones 602, 604. For example, the in-game world 300 may include one or more explorable zones 600 within which player movement depletes currency whilst the player searches for monsters and other collectibles hidden within the explorable zone(s) 600. The in-game world 300 may also include one or more city zones 602, 604 within which player movement does not deplete the currency. In city zones 602, 604, the players may accomplish various in-game tasks, store collected items, craft or alter items, interact with other players, etc.

The in-game world 300 may be a continuous world, wherein the player can move freely between the various zones, including areas between city zones. In other words, the in-game world 300 can include explorable areas rather than being comprised of a few predetermined (i.e., unexplorable) points or locations at which the in-game character is shown.

The in-game world 300 can be interactive wherein the player can freely explore the in-game world 300 and select various points of interests and/or in-game elements within the in-game world 300, such as monsters or other collectibles hidden about the in-game world 300. The in-game world 300 can be uniformly generated for all players so that the players experience the same in-game world 300 at a given time or the in-game world 300 can be uniquely generated for each player such that each player has a unique experience, wherein the in-game world 300 is specifically tailored to each player based on the player's individual fitness data. For example, in creating a uniquely generated in-game world 300, the fitness data processing module 226 and the element generation module 228 may process a particular player's fitness data and subsequently generate and/or populate the in-game world 300 with monsters, and the rarities thereof, based on the fitness data of the player and/or a grouping of players. In this regard, the system 100 can incentivize players or provide handicaps for players to encourage the player to perform additional fitness activities. Therein, the in-game world 300 can be individually tailored based on the fitness data and/or the in-game progress of the player individually and/or a grouping of players.

For example, in one embodiment, the element generation module 228 may populate a uniform in-game world 300, wherein the placement and rarity of the monsters depends upon a distance from the city zones 602, 604 and/or points of interest in the game world, or map thereof. As shown in FIG. 6, the element generation module 228 has placed the rarest monsters furthest away from the two city zones 602, 604. Thereby, each player will be incentivized to perform more fitness activities in order to be awarded with more rare monsters and other items. In another embodiment, the element generation module 228 may dynamically populate the map 300 with monsters based upon a player's individual fitness data or a grouping of players'fitness data. For example, if a player has achieved a streak, such as of three days in a row of fitness activity, the element generation module 228 may repopulate the in-game world 300 with more rare monsters that are closer to the city zones 602, 604, thereby providing an advantage or perk for players that consistently perform fitness activities.

In one embodiment, the element generation module 228 may selectively hide and unhide items, e.g., monsters, events, and/or activities based on the fitness data of the player or grouped players. For example, the element generation module 228 may hide a specific rarity of monster until the player obtains a threshold amount of fitness activity and/or currency generated therefrom. Thereby, the element generation module 228 may position items throughout the in-game world 300, uniformly for all players, and thereafter specifically tailor the in-game world 300 for each player by hiding various items based on the player's fitness data.

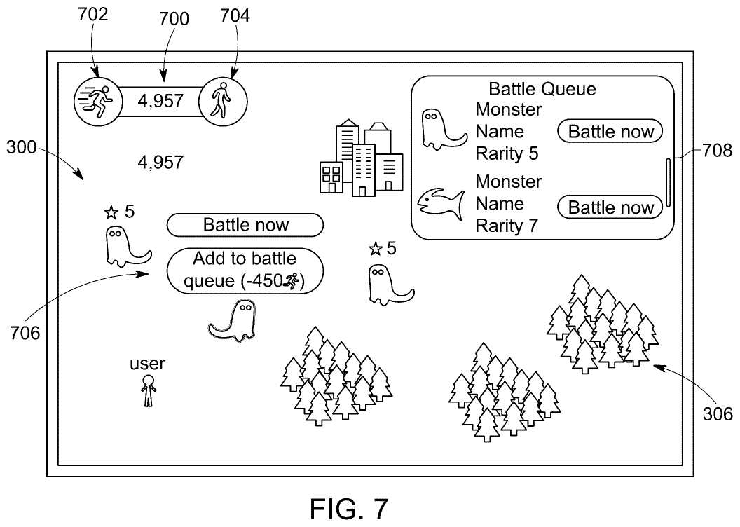

Referring now to FIG. 7, there is shown another example of a graphical user interface of a game world 300, or map thereof, which is generated at least in part upon the fitness data. The in-game world 300 can display the in-game character of the player, various locations, items, and one or more option overlays. In one embodiment, the in-game world 300 includes a currency overlay 700 that is overlayed onto the in-game world 300. The currency overlay 700 informs the player of the total amount of currency which was generated by the element generation module 228 from their fitness data (or group's fitness data), whether performed in a prior fitness activity and/or real time fitness activity. In other words, if the game server 200 stores the currency, then the currency overlay 600 can be in the form of a currency ledger overlay 600.

In one embodiment, the in-game world 300 further includes one or more activity (or item) option overlays 702, 704, 706, 708 which inform the player of various options of whether and how the currency may be used on an in-game activity. Each option overlay can be a standalone overlay or it may be incorporated into other overlays in relation to other features or items, such as the currency overlay 700 or a popup window for a monster. In some embodiments, the option overlay(s) can allow the player to move the in-game character at a set distance in the in-game world, move the in-game character at a set speed throughout the in-game world (with movement occurring in the background or foreground), collect and store one or more in-game virtual monsters in a battle queue (e.g., auto-catch monsters), auto-battle one or more virtual monsters, scan an area of the in-game world 300 for collectible items, including virtual monsters, perform and/or queue one or more in-game tasks (e.g., mining supplies, crafting, etc.), and/or speed up the one or more tasks which decreases a preset completion time of the one or more tasks.

In one embodiment, the in-game world 300 can further include one or more speed or rate of travel option overlays 702, 704 that can be positioned next to the currency ledger overlay 700. The speed option overlay 702 may display a button and/or icon, such as a runner icon, walker icon, etc., to indicate that the player has the option to select one or more speeds of travel. The speed option overlay 702 may also include a corresponding button and/or icon for a fast-travel (instantons travel) option. Therein, the player may have the option to select the rate of depletion of the currency as the player moves about the in-game world 300. In one embodiment, the option overlay 702 can be in the form of one button 702 that allows the player to select a walking speed, a running speed, and/or a sprinting speed. In one embodiment, the in-game world 300 may include two separate option overlays 702, 704 for respective speeds, such as walking and running. In one embodiment, the selection of a speed of travel may also include additional perks such as temporary invisibility and invincibility.

In one embodiment, the in-game world 300 includes an item option overlay 706 that can display an option to spend the currency to provide an advantage to the player. For instance, upon selecting a monster, an option overlay 706 in the form of a popup window may be displayed above the selected monster. In another embodiment, the option overlay 706 may automatically be displayed upon the in-game character encountering the monster, e.g., entering a proximity zone surrounding the monster, without the player tapping on or otherwise selecting the monster.

The option overlay 706 may include a first button to battle the monster at the present moment, wherein the player fights the monster in order to capture the monster. The option overlay 706 may also include a second, currency feature button to instantly add the monster to the battle queue, without presently battling the monster, wherein in the player spends a certain amount of currency, e.g., 450 incremental distance units, to automatically queue the monster so that the player may battle the monster at a later time via accessing a battle queue overlay 708 when the player is ready to battle the collected monster(s). For instance, if the player does not wish to return to this particular area of the in-game world 300 to re-find the monster, the player may automatically store the monster in the battle queue by selecting the corresponding currency feature button. Thereby, at a later time, the player may access the battle queue, for example, after the player has added certain perks or increased their stats in order to increase the probability of winning the battle. In essence, such a currency feature button gives an advantage to the player by allowing additional time to increase their skills or stats and/or save time in playing the game by circumventing the need to re-explore a given area of the in-game world 300 to re-find the monster in question.

To provide the battle queue overlay 708, the one or more processors 222 may initially generate a battle queue. The battle queue may include at least one previously generated virtual element. For example, the element generation module 228 can generate a battle queue of some or all of the battle options so that the player may battle monsters. The one or more processors 222 may thereafter generate the battle queue overlay 708 that is displayed over the in-game world 300. The battle queue overlay 708 may include a scroll button to scroll through the available items which may be subsequently battled upon selection thereof. Thereby, the player may complete their fitness activity without distraction and choose to battle the monsters at will, whether or not the player is actively doing a fitness activity.

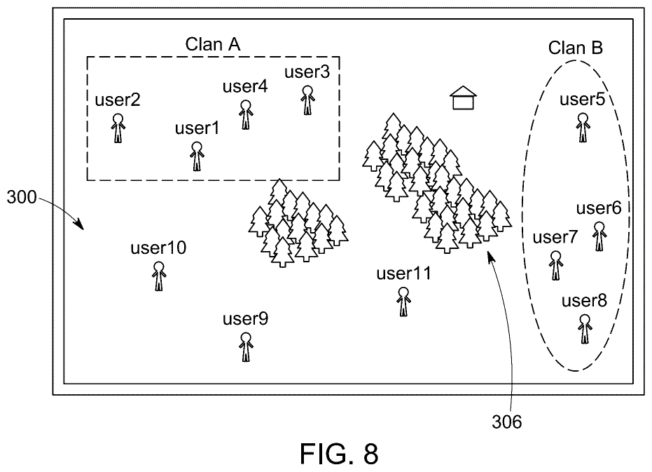

Referring now to FIG. 7, there is shown another example of a graphical user interface of an in-game world 300, or map thereof, with multiple players therein who can see and/or interact with one another. Some of the players may be grouped into subgroups or clans, as shown by the phantom peripheries of Clan A and Clan B. The element generation module 228 may or may not assign a clan to a player. In some embodiments, the player may self-select a clan based on various characteristics, such as a geographical region, an interest group, a type or classification of a fitness activity, or other characteristic. In some embodiments, the element generation module 228 may automatically assign a player to a clan based on various player characteristics, the fitness data of the player in question, and the fitness data of the clan. For instance, the element generation module 228 may initially assign an in-game value of the player based on fitness data, amount of currency, daily streaks, items collected, battles won, fitness or in-game achievements, etc. The element generation module 228 may then compare and group players based on their assigned values. For instance, a player who may have a lessor amount of in-game currency, but who has a high likelihood of in-game success as indicated by the assigned value, may be assigned to a clan with members that each, on average, have more currency (and thus a slightly greater assigned value) than the player. In so doing, the element generation module 228 may help motivate this player by pairing the player with peers that are slightly better, thus motivating the player to exercise more in order to become a valuable group member and better assimilate into the clan. Each clan may include its own zone, such as a clubhouse or a section of a city zone. As can be appreciated, some players may not wish to join a clan and may instead play as individuals without a clan, as indicated by the in-game characters that are not within a clan periphery (i.e., outlined border) in FIG. 8.

The element generation module 228 may also automatically remove players from a clan and/or reassign players to a new clan based on the fitness data. For example, if the player begins to fall below a clan fitness threshold or target exercise goal, then the element generation module 228 may automatically remove the player from the clan. In one embodiment, the game server 200 may prompt the players within a given clan to vote on whether or not a particular player should be removed from the clan. For instance, if a player stops exercising, thus falling below the clan fitness threshold, the players in the clan may vote to remove said player.

The element generation module 228 may generate currency based on individual players in isolation and/or as grouped together within a clan. In one embodiment, the element generation module 228 may pool all of the generated currency from each player in the clan, wherein each individual from the clan can use the pooled currency as desired. In one embodiment, the element generation module 228 may provide separate currencies, one for the individual and another for the clan as a collective. In this regard, each player may spend currency from their personal currency ledger or from the clan currency ledger. In some embodiments, the element generation module 228 may provide a clan currency based on in-game achievements instead of fitness data, such as the number of battles won, daily streaks, the total number of monsters collected, percentage of the map explored, etc.

It is noted that the in-game world 300 does not show the real world locations of the players, as the in-game world 300 is not an exact replica of the real world with exact or approximate locations of the players therein. Instead, the in-game world 300 is location independent. The location of the in-game character in the in-game world 300 is independent of the real world location of the player. As such, each player's real world location is never shown in the in-game world 300 nor known to the other players. In other words, the character location (of the in-game character in the in-game world 300) is independent and separate from the player's location in the real world. Therein, traversal of the in-game world 300 is more convenient and safer for players because players need not disclose their exact or approximate location or travel to and congregate at a particular location (which may be unsafe so instead they may exercise wherever desired). Furthermore, the fitness data received and processed by the game server 200, to generate the currency, does not include personally identifiable information. Thus, a malfeasor cannot obtain the location or other personally identifiable information from the in-game world 300 or game server 200. Thereby, the in-game world 300 and game server 200 help to protect the identity of each player whilst also allowing the players to see and interact with each other during gameplay, e.g., when exploring the various zones 600, 602, 604 of the in-game world 300.

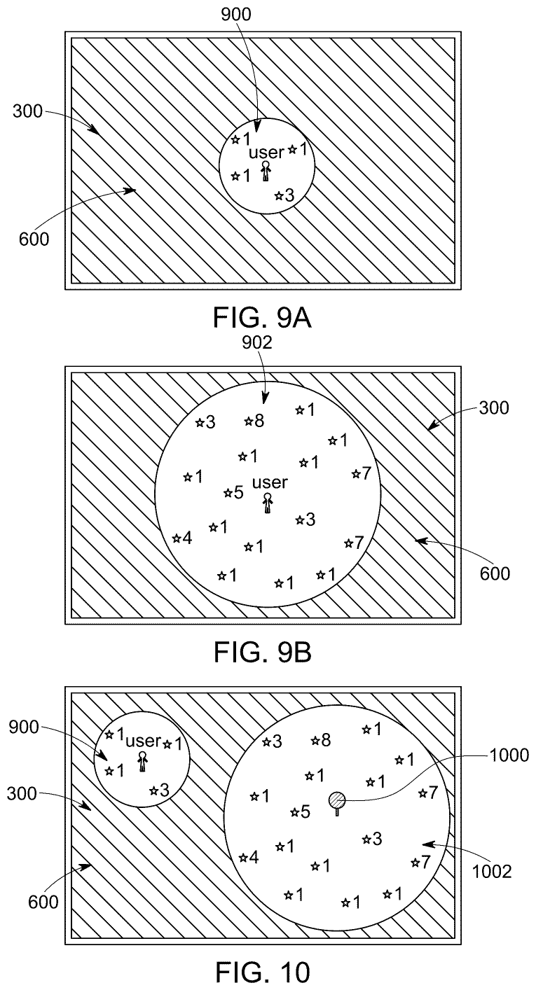

Referring now to FIGS. 9A, 9B, and 10, there are shown examples of viewing windows 900, 902 within an explorable zone 600 of the in-game world 300 that is otherwise hidden from view. In one embodiment, the explorable zone 600 has an opaque or blurry overlay that hides the items or other in-game features from view of the player. Thereby, the player cannot see the items and features of the in-game world 300 outside of the viewing windows 900, 902 (e.g., a proximity zone surrounding the in-game character that reveals the in-game world 300), as indicated by the diagonal lines.

FIG. 9 illustrates a typical player proximity zone or standard view 900 which reveals a relatively small portion of the in-game world 300. FIG. 10 illustrates an expanded view 902 that is larger, for example double or triple the size of the standard view 900. In some embodiments, the expanded view 902 may be purchasable by the player via a corresponding button or icon in an option overlay. Hence, for a certain amount of currency, the player may expand their view at will to more easily explore the in-game world 300.

In some embodiments, the element generation module 228 automatically adjusts the size of the window based on the fitness data of the player. For instance, if the player is presently exercising, such as walking, the element generation module 228 may award a bonus wherein the standard view is enlarged into the expanded view. When the player stops walking, the standard view may be reinstituted.

In one embodiment, the size of the viewing window 900, 902 is based upon the fitness data. For instance, the element generation module 228 may automatically expand the viewing window 900 upon determining that the player has exceeded a threshold heart rate (in real time or for the specific amount of time that the player is at or above the threshold heart rate). In one embodiment, the size of the viewing window 900, 902 can be variable, in real time or within a given fitness activity. For instance, if the viewing window 900, 902 is varied in real time, the size of the proximity zone thereof will expand and retract based on the player's speed and/or heart rate intensity in real time. Additionally, for instance, if the viewing window 900, 902 is varied based on historical fitness data, the size of the proximity zone thereof may expand and retract based on the player's speed and/or heart rate intensity at specific time stamps within a particular and previously recorded fitness activity.

FIG. 10 illustrates a scan feature in which the player can drop a pin 1000 at a given area, and thereafter a proximity zone 1002 revealing the corresponding area of the explorable zone 600 will be displayed around the dropped pin 1000. The proximity or scan zone 1002 of the dropped pin 1000 can be significantly larger than the proximity zone of the standard view 900. The element generation module 228 may initially generate a pin-drop option overlay with one or more buttons and a movable pin to allow the user to select and drag the pin to a desired area. The scan feature may cost a predetermined amount of currency. Alternatively, the scan feature may be available based on real time fitness activity of the player.

Referring now to FIG. 11, there is shown a flowchart of a computer-implemented method 1100 according to an exemplary embodiment of the present disclosure. The fitness data can be sensed and accordingly retrieved by at least one device of the one or more devices 104A-C, 106 of the players (at step 1102). In a background or foreground process, the device(s) 104A-C, 106 may send the fitness data to the network 102 (at step 1104). The game server 200 may then receive the fitness data (at step 1106). Once the fitness data is received, the one or more processors 222 will determine the type of fitness data, be it GPS location data, a time duration of a fitness activity, a total number of steps, steps per minute, heart rate data, e.g., an average heart rate, heart rate range(s), etc., an actual distance traveled at a particular speed or gate, an estimated distance traveled based on location data and/or heart rate intensity, calories burned, and/or other fitness data. Then, one or more virtual elements can be generated by the one or more processors 222 (at step 1108). For example, the in-game world 300, including the map and/or mini map thereof, and the in-game character therein can be generated for each player. In one embodiment, the one or more processors 222 can initially generate the game world 300 and thereafter update the game world 300 with the in-game character and various in-game elements.

The one or more processors 222 may generate an in-game currency based on the fitness data from one player individually and/or a grouping of players (at step 1110). Optionally, in generating the in-game currency, the one or more processors 222 may also initially generate a fitness conversion ratio, such as a 0.5:1, 1:1, 2:1, 10:1 or greater, conversion ratio, which is at least in part based upon the fitness data (at step 1112). For example, the one or more processors 222 may provide a single conversion ratio or multiple conversion ratios for one or more types of fitness activities. If the fitness data includes differing types of fitness activity markers, such as GPS location data within a period of time and heart rate data, the one or more processors 222 can generate two corresponding conversion ratios therefor. In generating the in-game currency, the one or more processors 222 may generate the currency via multiplying the fitness data by the conversion ratio(s). Additionally or alternatively, the one or more processors 222 may generate the currency via a conversion equation, wherein the fitness data is inputted as a variable amongst other variables including various conversion ratios (which may be keyed to specific types of fitness data), clan data, and/or player information, such as player characteristics, in-game player level, monsters collected, battles won, streaks, bonus achievements, etc.

By way of example only, if the fitness data is a number of steps, the currency can be generated in a background process upon receiving the fitness data from the device(s) 104A-C, 106 of the players, by multiplying the number of steps by the conversion ratio. The in-game currency can thus be directly linked to the steps of the user throughout a given time period.

Further, by way of example, if the fitness data is heart rate data, the currency can be generated by initially establishing an average heart rate and/or one or more ranges of heart rates or zones. For instance, the one or more processors 222 may initially establish a resting heart or optimal heart rate range of the player (or an average based on certain characteristics of a grouping of the players), and thereafter determine a total time that the player's heart rate was above this baseline heart rate range. The game server 200 may initially establish the resting heart rate (or range) by calculation based on the player's heart rate data within a longer duration of time, e.g. polled over the course of a 48-hour period. Alternatively, the player may initially input their resting heart rate, or other information like their age, biological sex, height, weight, BMI, and current or desired heart rate range. Alternatively, the resting heart rate used by the game server 200 may not be tailored specifically to a given player.

Once a resting or optimal heart rate (or range) is established, the game server 200 may poll the devices 104A-C, 106 to obtain the player's heart rate, at any given time or upon request of the player. Thereafter, the player's heart rate taken at certain time intervals can be multiplied by a corresponding conversion factor to yield units of currency. For instance, 10 minutes of elevated heart rate times a conversion factor of 5.5 would yield 55 in-game units of currency. As another example, the time spent at or above a particular threshold heart rate (or range of heart rates) can be converted into in-game currency or distance units by multiplying the time by a conversion factor. For instance, a 10× multiplication factor can be used to convert 1 minute of a heart rate above 120 beats per minute into 1,200 (or 1 km) in-game steps. The game server 200 may also incorporate various ranges of heart rate zones such as a fat burning zone, anaerobic zone, aerobic zone, etc., which can currency factors keyed thereto for generating the in-game currency.

Additionally, in another example, the one or more processors 222 may probe the devices 114A-C, 106 of the player for the player's heart rate at certain time intervals and thereafter generate currency based on predetermined factors keyed to particular heart rates or ranges thereof. An initial threshold heart rate may be set by the game server 200, and if the player's heart rate registers above this preset threshold heart rate, the game server 200 may subsequently poll the player's heart rate at preset intervals. In one example, the game server 200 may add together currencies from individual time stamps in a given activity or time period. For instance, the devices 114A-C, 106 may be polled once every 15 seconds to obtain the player's heart rate during a fitness activity. For instance, three time stamps may be taken, wherein a first heart rate of 140 bpm (at a first time interval or time zero) may have a high conversion rate of +20 fitness currency per second of activity, a second heart rate of 120 bpm may have a conversion rate of +5 fitness currency per second of activity, and a third heart rate of 90 bpm may have a conversion rate of 0 because it is too low to be considered a fitness activity. The game server 200 may then add together the generated the currencies from the time stamps and add the total currency amount to the currency ledger.

Still further, by way of example, the received heart rate data (e.g., beats per minute, ranges or zones of heart rate intensity, and/or time spent within a range of or at a specific heart rate) could be converted into in-game currency via one or more predetermined functions, which may be keyed to specific heart rates, ranges thereof, and/or durations thereof. Initially, the heart rate data can be processed to determine a heart rate intensity over a given time period. The heart rate data can be mapped onto a graph of a given function, such as a quadratic function, wherein the Y-axis signifies the time and the X-axis signifies the heart rate intensity, i.e., beats per minute, and further wherein each integer along the X-axis corresponds to a multiplication factor, that provides for a greater generation of currency at an optimal range and a diminished generation of currency at the extremes (at both extremes of a low heart rate and a high heart rate). Additionally, in one embodiment, the currency can be generated via a sigmoidal function, wherein higher heart rates yield marginal benefits. In this regard, currency generation may be likened to a normal distribution calculation over a given time period or fitness activity, akin to a bell-curve. By way of example only, if the fitness data is GPS location data, the one or more processors 222 can initially calculate a total distance traveled, a speed of travel, and a total time of movement of the user. The one or more processors 222 may also determine the type of activity, such as walking or running. Thereafter, the one or more processors 222 may generate a conversion ratio based on a pre-assigned factor correlated to the type of activity, the speed of travel, and/or the total distance traveled. For instance, if the player ran a total distance of 5 miles at a speed of 8 minutes per mile, the one or more processors 222 may assign a first conversion factor on account of the total distance traveled and assign a second conversion factor to the speed of travel, and subsequently adding the conversion factors together and multiplying this combined conversion factor by the total distance traveled to yield a total amount of in-game currency.

In alternative example of heart rate data, the movement of the in-game character can be directly tethered to the player's heart rate. For instance, the game server 200 can poll the player's heart rate at certain time intervals and move the player's in-game character at a distance and/or speed proportional to the player's heart rate. Therein, the game server 200 may not calculate and use fitness currency as a medium and instead use the player's heart rate in real time to move, e.g., walk or run, the player's in-game character throughout the in-game world.

By way of example only, if the fitness data is a combination of GPS location data, heart rate data, step data, and activity time, the one or more processors 222 may initially generate unique conversion factors for each data type. As discussed above, each conversion factor can be multiplied by the fitness data. The converted fitness data can thereafter be added or multiplied together to yield a total amount of in-game currency. Additionally, the one or more processors may combine the various conversion factors into a single, greater conversion factor that is subsequently used to multiply a particular type of fitness data, such as the total distance traveled by the user or the total activity time, in order to yield a total amount of in-game currency. Thereby, the one or more processors 222 may generate currency based on multiple differing types of fitness data for a given fitness activity.

In one embodiment, the one or more processors 222 may also generate a clan bonus that can be a separate clan currency (usable by each group member) or be added or multiplied to the currency generated on behalf of the individual player to generate a greater total amount of currency. For instance, the fitness data be multiplied by a clan conversion ratio (which can be greater than or less than the individual conversion ratio) to accordingly generate a clan specific currency usable by the clan. Alternatively, the individually generated currency and the clan currency can be added or multiplied together to provide a greater amount currency for the individual player to use. Hence, the player may receive additional bonuses by being a part of a clan.

The one or more processors 222 may also generate an expenditure ratio at which the generated currency is depleted, based on the type of fitness data and/or the in-game activity (at step 1114). For example, a depletion ratio may be generated for in-game player movement and a separate depletion ratio may be generated for an in-game activity, such as purchasing an item or accomplishing an idle task within a city zone. Hence, in some embodiments, the depletion of the currency may be specifically keyed to a specific type of in-game activity. In some embodiments, certain in-game activities may not have a depletion ratio and may instead have a predetermined cost. For instance, a rarity value of a monster may have an assigned depletion ration (such that the cost of options is graduated for the rarities of monsters) or the option itself may have a fixed cost, for example it may cost 450 units of currency to queue a monster (regardless of rarity) instead of battling the monster upon finding the monster in an explorable zone 600.

The one or more processors 222 may transmit the in-game world and the currency to the device(s) 104A-C, 106 of the players (at step 1116). Each device 104A-C, 106 may display the in-game world 300 and the currency amount thereon (at step 1118). During gameplay, the one or more processors 222 may prompt the player to input various commands to in order to conduct an in-game activity, such as moving about the in-game world 300 or choosing to accomplish certain in-game activities (at step 1120). For example, the user may select an option to spend the generated currency to increase the speed of travel, fast-travel to a particular location, speed up an in-game activity, purchase in-game items, increase or add to the stats, or level up, their character and/or items (including monsters), increase or add to the stats of the player's group, purchase various perks, auto-catch or tag monsters to queue the monsters, auto-battle monsters, unlock playable zones of the in-game world, etc. Depending upon the user inputted command, the one or more processors 222 will deplete the currency (at step 1122). Thereafter, the one or more processors 222 will update and retransmit the currency amount to the device(s) 104A-C, 106 (at step 1124).

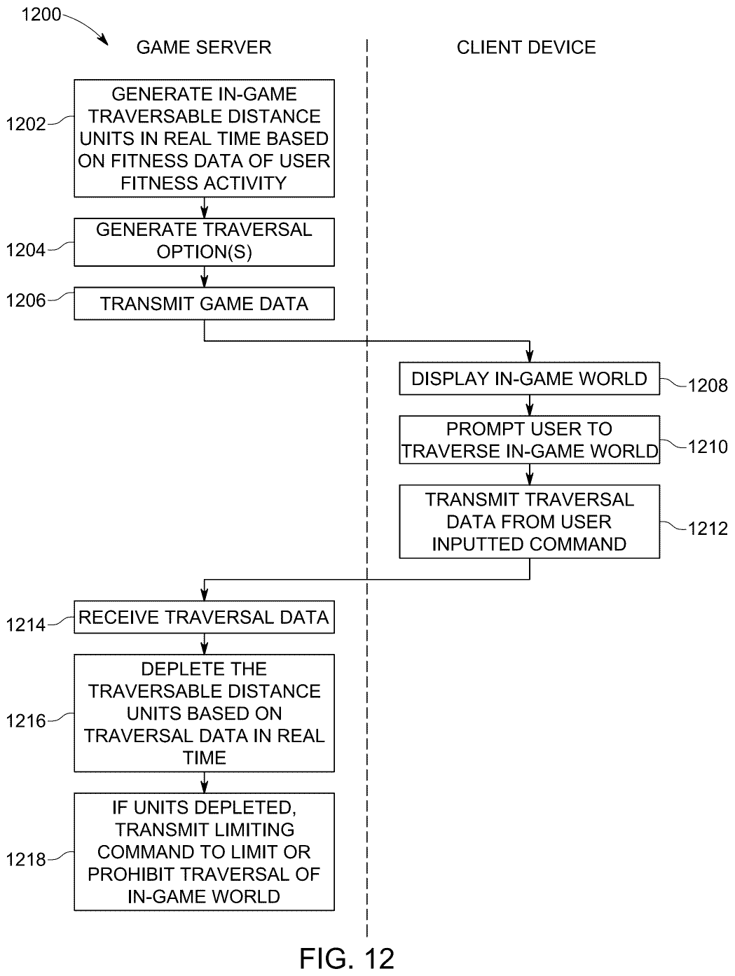

Referring now to FIG. 12, there is shown a flowchart of a computer-implemented method 1200 according to an exemplary embodiment of the present disclosure. The one or more processors 222 can generate an in-game traversable distance in real time based on fitness data from a user fitness activity (at step 1202). Therein, a distance traveled in-game can be directly keyed to real world movement. For example, a number of steps in the real world can equate to the same number of steps in the game world. Additionally, for example, heart rate data can be converted into an in-game unit of distance in real time via assigning a predetermined conversion factor to a particular heart beat per minute (or range thereof), which may or may not be specifically tailored to a player by initially calculating the player's resting and optimal elevated heart rate range during a fitness activity.

The one or more processors 222 can generate one or more traversal options (at step 1204). For example, as discussed above, the in-game world 300 may include a tap based, freeform, preset directional based movement modality, or other movement modality to allow the player to explore the in-game world 300. The one or more processors 222 may then transmit the in-game world 300 to the device(s) 104A-C, 106 (at step 1206). Optionally, the one or more processors 222 may also transmit the total amount of the traversable distance for display on the in-game world 300. In an alternative embodiment, the amount of traversable distance may not be transmitted to the device(s) 104A-C, 106 in conjunction with the in-game world 300. Once received, each device 104A-C, 106 may display the in-game world 300 (at step 1208). Optionally, the generated traversable distance may also be provided as an overlay onto the in-game world 300, for example as part of a real time overlay display. The one or more processors 222 may then prompt the player to move the in-game character and explore the in-game world 300 (at step 1210). As the player moves the in-game character via one of the movement modalities, the device(s) 104A-C, 106 will send the traversal data of the in-game character to the game server 200 (at step 1212). Thereafter, the game server 200 may then receive the traversal data inputted by the player (at step 1214). In real time, the one or more processors 222 can then deplete or otherwise consume the generated units of traversable distance based on the received travel data (at step 1216). Optionally, prior to effectuating in-game movement and depleting the distance currency, the one or more processors 222 may initially verify a validity of the inputted request for traversal of the in-game character. For example, the one or more processors 222 may verify that the inputted traversal data is an allowed movement within the boundaries and/or unpassable elements of the game world (e.g., the request to move the in-game character does not attempt to move the in-game character through a wall, structure, or beyond a border of the game world). Hence, the one or more processors 222 may help preserve the generated in-game units of traversable distance. The one or more processors 222 may also automatically modify or redirect the user inputted command to move the in-game character in a valid manner within the game world. If all of the units of traversable distance are depleted, then the one or more processors 222 may generate and transmit a corresponding command to the device(s) 104A-C, 106 in order to limit or prohibit player movement in the game world (1218).

By way of example only, the player can move their in-game character via a tap based modality. In this tap based movement embodiment, the player may open the in-game world and tap or otherwise select a desired destination. Upon receiving the desired destination, the one or more processors 222 can generate multiple differing pathways, with each being optimized for a particular purpose, such as a shortest, least expensive pathway, an item optimized pathway, or a story or event optimized pathway. The one or more processors 222 may generate an informative pathway overlay for each optional pathway (which may include the cost of the pathway, the time of travel, the reason of optimization, etc.) and thereafter prompt the user to select a desired pathway. The player can then select which pathway they would like and the in-game character will accordingly start moving along the pathway. The one or more processors 222 will receive fitness data in real time, generate units of the traversable distance, and will move the in-game character along the selected pathway whilst depleting the units of traversable currency. Thus, as the player moves in the real world, the in-game character in the in-game world of the game world will also move in real time and in proportion to the real-world speed of travel (or intensity) of the player during their fitness activity. If the user stops a fitness activity, the one or more processors 222 may suspend movement of the in-game character on the pathway and accordingly notify the player. Alternatively, instead of stopping the in-game character, the one or more processors 222 may allow the in-game character to keep moving along the pathway but at a reduced speed. If and when the player starts another fitness activity, the one or more processors 222 may regenerate units of traversable distance and begin moving (or accelerating) the in-game character along the pathway.

Additionally, by way of example only, the player can move their in-game character via a preset directional based movement. In this preset directional movement embodiment, the player may initially select a desired direction of travel in the in-game world. Thereafter, the one or more processors 222 may generate units of traversable distance in proportion to the type of activity, amount thereof, and speed (or intensity) thereof. As the player moves in the real world, the one or more processors 222 can move the in-game character in preselected direction within the in-game world 300, or map thereof, via depleting the generated units of the traversable distance. The player can change directions at any desired time. In some embodiments, as a means for semi-passive gameplay, the one or more processors 222 may automatically stop the in-game character upon encountering an item or story event and accordingly notify the player. If the user stops the fitness activity in the real world, the one or more processors 222 may suspend or slow the movement of the in-game character on the pathway of the in-game world 300 and accordingly notify the player.

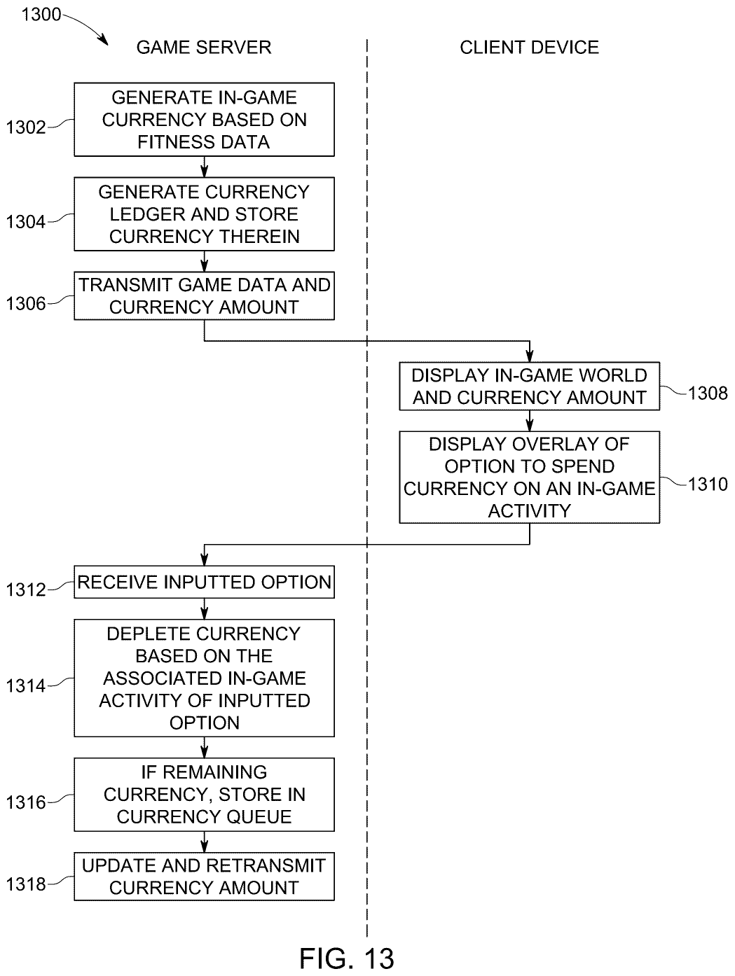

Referring now to FIG. 13, there is shown a flowchart of a computer-implemented method 1300 according to an exemplary embodiment of the present disclosure. The one or more processors 222 can generate an in-game currency based on the fitness data, as discussed above (at step 1302). Thereafter, the one or more processors 222 may generate a currency ledger or queue to store the generated amount of currency therein (at step 1304). Hence, in this embodiment, the currency may not be time dependent and thus can be stored and used at any time by the player. The one or more processors 222 can transmit the in-game world and information regarding the generated currency, e.g., the currency ledger, to the device(s) 104A-C, 106 (at step 1306). During gameplay, each device 104A-C, 106 can display the in-game world 300 and currency information (at step 1308). The one or more processors 222 can also generate an option overlay, as discussed above, which informs the player of and allows the player to select an option to spend the currency on an in-game activity (at step 1310). The in-game activity may include a running speed of movement, a fast-travel option, an option to automatically queue monsters in a battle queue, automatically battle a monster, an option to perform an in-game task, etc. The game server 200 can receive the player inputted option (at step 1312). When performing the selected activity, the one or more processors 222 may deplete the currency based on the associated in-game activity of the inputted option (1314). If the currency is depleted, the one or more processors 222 can stop or slow the in-game activity until the player performs an additional fitness activity. If there exists remaining currency, the one or more processors 222 may store the currency in the currency queue for subsequent usage by the player (at step 1316). The one or more processors 222 may update and retransmit the currency amount of the currency ledger to the device(s) 140A-C, 106 (at step 1318).

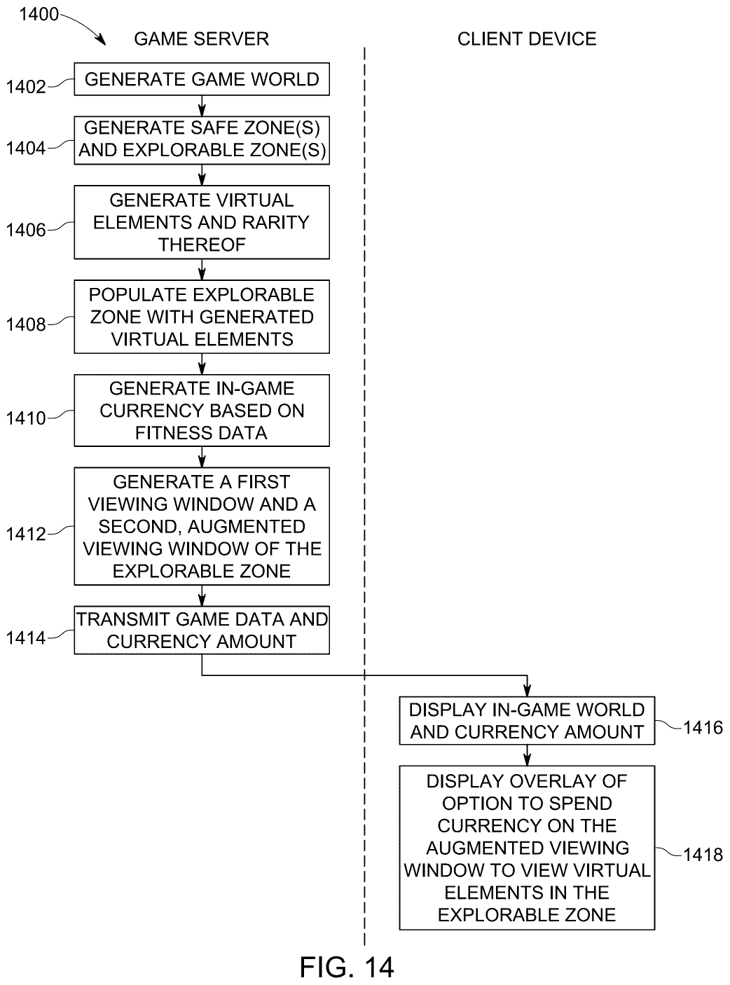

Referring now to FIG. 14, there is shown a flowchart of a computer-implemented method 1400 according to an exemplary embodiment of the present disclosure. The one or more processors 222 may generate in-game world, and map thereof, including the in-game location of the player's in-game character (at step 1402). The one or more processors 222 may also generate one or more zones 600, 602, 604 of the in-game world 300 (at step 1404). For example, the one or more processors 222 may generate at least one explorable zone 600 and at least one city zone 602, 604. Within the explorable zone 600, player movement may or may not deplete a certain amount of currency. Within the city zone 602, 604, player movement may not deplete currency.

The one or more processors 222 may then generate virtual elements and a rarity value thereof if applicable (at step 1406). For example, the one or more processors 222 may generate multiple monsters and also generate and assign a rarity value thereto. Then, the one or more processors 222 may populate the explorable zone with the generated virtual elements (1408). In some embodiments, the one or more processors 222 may position the rarest items furthest away from the city zone(s) 602, 604 and the least rare items closer to the city zone(s) 602, 604. In some embodiments, the one or more processors 222 may position or reposition or hide and unhide the generated virtual elements in the explorable zone based upon the collected fitness data. For example, if the player has dropped below a particular baseline of physical activity (based on historical, player-specific fitness data), the one or more processors 222 can attempt to remotivate the player by positioning a rare item, e.g., high-value monster, closer to a city zone, thus upon encountering the rare item the player may become motivated to increase their physical activity in order to battle, queue, build out, or otherwise use the encountered item.

The one or more processors 222 may generate an in-game currency based on the fitness data, as discussed above (at step 1410). The one or more processors 222 may also generate multiple viewing windows (e.g., a proximity or scope) of a viewable area of an explorable zone which is otherwise hidden (at step 1412). For example, the one or more processors 222 may generate a first, default viewing window at a preset proximity around the in-game character which allows the player to see nearby items and in-game features within hidden areas of the explorable zone. Additionally, the one or more processors 222 may generate a second, augmented viewing window that has a larger area than the default viewing window. The game server 200 may transmit the in-game world 300 and currency amount to the device(s) 104A-C, 106 (at step 1414). During gameplay, the device(s) 104A-C, 106 may display the in-game world 300 and currency amount (at step 1416).

The one or more processors 222 may also cause the device(s) 104A-C, 106 to display a generated option overlay to utilize the augmented viewing window at a certain cost (at step 1418). For example, the option overlay may comprise an on/off button or a listing of predetermined time durations with an associated cost thereof which the user may select to expand their viewing window for a desired amount of time. Additionally or alternatively, for example, the option overlay may comprise a pin-drop feature that allows the player to drop a pin at a desired location in the explorable area which will accordingly open up an augmented viewing window around the pin. Any items in the explorable area will be revealed within the viewing window. In this regard, the player may drop one or more pins to explore the in-game world without needing to travel to a given area within the in-game world.

In some embodiments, the above-described method steps of the methods can be executed or performed in any sequence, and thereby the methods are not limited to the sequence as shown and described. Additionally, the method steps of the methods can be performed substantially simultaneously, in order to reduce latency and processing times. Additionally, some of the method steps of the methods may be entirely omitted.

The method steps of the methods described herein can be performed by executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Each method can be performed by one or more processors, a controller, and/or any other desired processing device. The term “software code” used herein refers to any instructions or set of instructions that influence the operation of a computer or controller. Such software code may exist in a computer-executable form, such as machine code, which is the set of instructions and data directly executed by a computer's central processing unit or by a controller, a human-understandable form, such as source code, script, etc., which may be compiled in order to be executed by a processing unit, a controller, or an intermediate form, such as object code, which is produced by a compiler. Furthermore, the software may include, in non-limiting examples, routines, programs, objects, components, and data structures that perform particular tasks or implement particular data types. The server processes may be implemented using a single server or multiple servers working in combination with one another. The server(s), database(s), and software application(s) may be implemented on a single system or distributed across multiple systems.

Other embodiments, which differ from the aforementioned embodiments, may be recognized by those skilled in the art without departing from the scope of the following claims.

1. A computer-implemented method, comprising:
hosting, by a game server, a gaming module;
receiving, by the game server, fitness data from one or more devices of a user generated during gameplay, at least one device of the one or more devices comprising one or more sensors configured for sensing the fitness data;
generating, by one or more processors, an in-game world and an in-game character movable therein; and
generating, by the one or more processors, an in-game currency based on the fitness data.

2. The method of claim 1, wherein the currency is usable to move the in-game character throughout the in-game world.

3. The method of claim 1, wherein the currency is usable to accomplish one or more in-game activities including:
moving the in-game character in the in-game world;
moving the in-game character at a set speed throughout the in-game world;
collecting and storing one or more in-game virtual monsters in a battle queue;
auto-catching, auto-queuing, or auto-battling one or more virtual monsters;
scanning an area of the in-game world for in-game elements, including collectible items and/or virtual monsters;
queueing one or more in-game tasks; and/or
performing or speeding up the one or more tasks which decreases a preset completion time of the one or more tasks.

4. The method of claim 1, wherein:
in generating the currency, the fitness data is converted to the currency in real time; and
player movement, when moving the in-game character in the in-game world as directed by the user, is contingent on the currency which is generated in real time.

5. The method of claim 4, further comprising:
generating, by the one or more processors, a predetermined pathway to facilitate player movement in the in-game world; and
expending the currency to move the in-game character along the predetermined pathway in real time.

6. The method of claim 1, further comprising generating, by the one or more processors, a currency ledger wherein the currency is stored and subsequently usable by the user.

7. The method of claim 6, further comprising generating a currency overlay of the ledger that is displayed over the in-game world.

8. The method of claim 7, wherein the currency overlay is an interactive currency overlay, allowing the user to select one or more expenditure rates of the currency to speed up one or more in-game operations at a rate proportional to the one or more expenditure rates of the currency.

9. The method of claim 8, wherein each expenditure rate of the currency is based on the fitness data.

10. The method of claim 9, wherein the fitness data comprises heart rate data, and the method further comprises:
generating, by the one or more processors, a first expenditure rate based on a first heart rate range and a second expenditure rate based on a second heart rate range; and
wherein the second expenditure rate is higher than the first expenditure rate and the second heart rate range is higher in heartbeats per minute than the first heart rate range.

11. The method of claim 1, wherein the fitness data comprises a distance traveled by the user in the real world, a number of steps by the user, a heart rate of the user, an optimal heart rate of the user, and/or an exercise time of the user.

12. The method of claim 1, wherein, in generating the currency, the fitness data is converted to the currency via multiplying a total distance, a time, an average heart rate, or a number of steps of a fitness activity by a conversion factor.

13. The method of claim 1, wherein the fitness data comprises heart rate data, and in generating the currency, the heart rate data is converted into the currency via one or more predetermined functions.

14. The method of claim 1, further comprising:
generating, by the one or more processors, two or more zones including a first zone and a second zone;
the first zone is a safe zone within which player movement does not expend currency;
the second zone is an explorable zone within which player movement expends currency;
generating, by the one or more processors, one or more in-game virtual monsters;
generating, by the one or more processors, a rarity factor of each virtual monster based in part upon a distance, within the in-game world, from the safe zone; and
placing, by the one or more processors, the one or more virtual monsters on the in-game world in the explorable zone.

15. The method of claim 1, further comprising:
generating, by the one or more processors, one or more in-game items, including virtual monsters; and
prompting the user to spend the generated in-game currency to:
purchase the one or more in-game items;
unlock playable zones of the in-game world;
increase or add to in-game abilities of the in-game character; and/or
increase or add to in-game abilities of the virtual monsters.

16. A computer-based system for implementing a computer-implemented method of gaming, the system comprising:
a game server comprising one or more computer-readable media, one or more processors, and a network interface, the game server configured for:
hosting a gaming module;
receiving, by the network interface, fitness data from one or more devices of a user generated during gameplay, at least one device of the one or more devices comprising one or more sensors configured for sensing the fitness data;
generating, by one or more processors, an in-game world and an in-game character movable therein;
generating, by the one or more processors, an in-game currency based on the fitness data, the currency is usable to move the in-game character throughout the in-game world; and
transmitting, by the network interface, the in-game world to the one or more user devices of the user.

17. A computer-implemented method, comprising:
hosting, by a game server, a gaming module;
receiving, by the game server, fitness data from one or more devices of a user generated during gameplay, at least one device of the one or more devices comprising one or more sensors configured for sensing the fitness data;
generating, by one or more processors, an in-game world and an in-game character; and
moving the in-game character within the in-game world at a distance proportional to the fitness data.

18. The method of claim 17, further comprising:
generating, by the one or more processors, units of distance within the in-game world based on the fitness data; and
generating, by the one or more processors, a conversion ratio for converting the fitness data to the units of distance such that player movement in the in-game world is proportional to the fitness data of the user.

19. The method of claim 18, further comprising:
generating, by the one or more processors, an expenditure ratio for depleting the units of distance, wherein the expenditure ratio is dependent upon a speed of player movement.

20. The method of claim 17, wherein player movement, in moving the in-game character through the in-game world, is:
tap based such that the in-game character is movable between a starting point and a selected destination point, wherein a pathway between the starting point and the selected destination point is determined by the one or more processors and costs a corresponding amount of the units of distance;
freeform such that the in-game character is freely movable, by the user, in any direction throughout the in-game world such that each increment of movement costs a preset amount of units of distance; or
preset directional such that the in-game character is movable in a preselected direction, which is selectable by the user, and player movement is contingent on the fitness data.
